(19) United States
(12) Patent Application Publication
(10) Pub. No.: US 2007/0107316 A1
(43) Pub. Date: May 17, 2007

(54) Resin bonding type diamond tool and manufacturing method thereof

(76) Inventor: Hyo Young Kim, Suwon-si (KR)

Correspondence Address: IPLA P.A., 3580 WILSHIRE BLVD., 17TH FLOOR, LOS ANGELES, CA, 90010, US

(21) Appl. No.: 10/561,679

(22) PCT Filed: Jul. 2, 2004
(86) PCT No.: PCT/KR04/01640

§ 371 Date: Dec. 21, 2005

(30) Foreign Application Priority Data
Jul. 7, 2003 (KR) 10 2003 0045820

(51) Int. Cl. C22C 32/00; C09K 3/14

(52) U.S. Cl. 51/298; 419/10

(57) ABSTRACT

A resin bonding type diamond tool and manufacturing method thereof, in which the diamond tool is fabricated by preparing diamond pellets by sintering diamond powder and metal matrix, loading the diamond pellets into a mold and sintering the diamond pellets together with injected resin or powder resin. This can be applied to all tools of various shapes, in particular, complex tools having difficulty in fabrication, shorten a manufacturing process to save cost, time and molds, and remarkably improve the cutting ability of final products.

### TECHNICAL FIELD

The present invention relates to a resin bonding type diamond tool, which is formed by injection-molding or sintering granular type diamond pellets containing diamond powder with resin, and a manufacturing method thereof.

### BACKGROUND ART

As known in the related prior art, diamond tools are classified into metal bonding type, resin bonding type, vitrified bonding type, electroplated bonding type and so on according to the type of a matrix (i.e., binder) that binds diamond particulates. The present invention pertains to the metal bonding type tool among them.

The metal bonding type tool has an advantage in a prolonged lifetime due to a strong matrix, so it is generally applied to a steel grinding.

However, this type of tool has difficulty in shape-molding due to a lack of fluidity which is one

of manufacturing defects as a feature of high temperature sintering and a metal sintering, and it also requires a cold-forming die and a hot-forming die in order to form a desired shape during manufacturing. These dies should be prepared to have all the corresponding shapes which conform to a shape of the tool. If at least one or more of them is out of a certain shape, it is difficult to manufacture a die for mold and it is even often impossible to conduct sintering.

Meanwhile, a general cutting tool among the diamond tools of the prior art has been widely used due to its simple shape and has been manufactured with a reduced cost due to its innovative manufacturing methods, but many of the other tools for fabricating a special shape generally do not have competitiveness in manufacturing cost.

Such tools for fabricating special shapes, however, have some problems in that although aesthetic requirements to a fabricated shape are becoming more diversified according to the development of the masonry and construction industries, it is difficult to manufacture a working tool corresponding to a shape desired due to its irregularity and complexity. Also, the time and cost for manufacturing such tools make

barriers to tool manufacturers trying to expand their market share, which also impose a burden of increased cost on buyers. Thus, most latent consumers for the prior tools for fabricating special shapes adopt other working methods (such as manual working instead of machine-working) except an extremely special case even if such working tools are well known in the art. This also blocks the development of the masonry and construction industries and an expansion of market for diamond tools as well.

### DISCLOSURE OF INVENTION

Accordingly, the present invention has been made to solve the above-mentioned problems occurring in the prior art, and an object of the present invention is to provide a resin bonding type diamond tool and a manufacturing method thereof in which manufacturing liquidity is secured to obtain increased productivity and reduced cost, and resin is filled in the tools to provide an excellent cutting capability and chip discharge ability, and an improved cutting surface as well.

### BRIEF DESCRIPTION OF THE DRAWINGS

The above and other objects, features and advantages of the present invention will be apparent from the following detailed description of the preferred embodiments of the present invention in conjunction with the accompanying drawings, in which:

FIG. 1A is an sectional view of a diamond tool according to an embodiment of the present invention;

FIG. 1B is a plan view of FIG. 1A;

FIG. 2 is a construction view of diamond pellet employed in the present invention; and

FIG. 3 is a process view of an embodiment for manufacturing a diamond tool of the present invention.

### BEST MODE FOR CARRYING OUT THE INVENTION

The present invention will now be described in detail in connection with preferred embodiments with reference to the accompanying drawings. For reference, like reference characters designate corresponding parts throughout several drawings.

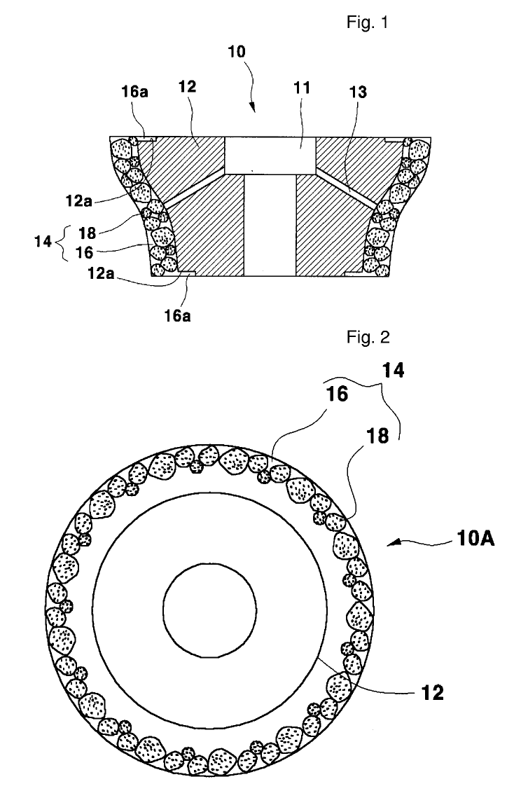

A resin bonding type diamond tool 10A of the present invention includes a tool body 12 made of metal or resin and a diamond tip 14 as shown in FIGS. 1A and 1B.

Particularly, the diamond tip 14 is an essential

element of the present invention, which consists of resin 16 and a great number of granular diamond pellets 18 contained in the resin 16. Wherein, the respective diamond pellets 18 are brazing-welded together to form a porous structure such as sponge, and are bound to the tool body by means of injection or sintering.

This provides the diamond tool with rigidity due to the bonding of the diamond pellets 18 to the same and the binding force of the resin, and secures all effects of the present invention.

Although the diamond pellet 18 preferably has a size of 3 to 5 mm in this embodiment, the present invention is not limited to the size, and the size can thus be varied according to the height of the diamond tip 14.

As shown in FIG. 2, the diamond pellet 18 has an irregular shape which is formed in a state that the mixture of the diamond powder 18a and the metal powder 18b is sintered.

Meanwhile, the diamond powder 18a can be substituted with Cubic Boron Nitride (CBN) powder.

A weight ratio of diamond powder 18a to each of the diamond pellets 18 is different according to grinding conditions and use, and a kind of material to

be cut, so that it may be determined to have a general ratio that is known in the related art to manufacture a diamond tool.

The resin 16 is the high strength polymer compound resin, for example, an engineering plastic.

Wherein, the resin 16 may be injected into a die to be filled between the diamond pellets 18. Alternatively, the resin 16 in the form of powder may be loaded into the die to be pressed and sintered together with the diamond pellets 18 at a high temperature.

The tool body 12 of the diamond tool 10A of the present invention may be made of metal or resin.

If the tool body 12 is made of resin, it does not require a separate welding like in the prior art because when the same kind of resin 16 is injected, the resin 16 containing the diamond pellets 18 is adhered to the tool body 12.

Meanwhile, if the tool body 12 is made of metal, various shapes of binding recesses 12a as shown in FIG. 1A are formed to secure a binding with the resin 16, and the injected or powder-sintered resin 16 is filled in the binding recesses 12a thus to form a plurality of binding projections 16a.

The reference numeral ‘11’ is a hole into which

an output terminal of an electric power tool is adapted.

As described above, a quantity of diamond pellets 18 are contained in the resin 16, that is to say, the resin 16 is filled between the neighboring diamond pellets 18, so that upon cutting, an intermittency effect and a function of chip pocket are achieved.

The function of chip pocket means that upon grinding cutting, a portion of surface layer of the resin 16 is lowered than that of the diamond pellets 18 to provide a space for storing cut chips because a hardness of the resin 16 is relatively lower than that of the diamond pellets 18.

With such intermittency effect and function of chip picket, there is provided a good chip discharge and an excellent exposure of abrasive grain, which thus improves a cutting capability.

Also, the diamond pellet 18 is brazed with neighboring diamond pellets 18 to maintain a strong binding state.

Meanwhile, in order to increase a binding force to the diamond pellets 18, the diamond tool 10A of the present invention may be formed in such a manner that a nonferrous metal such as copper, silver solder, silver, brass solder and so on is brazed.

Wherein, upon brazing, to prevent the diamond pellets 18 from fusion-absorbing of brazing material, the diamond pellets 18 are preferably metal-coated with a material such as Ni, Ti, Cu and so on.

Preferably, the coating material has a fusion point relatively higher than that of the selected brazing material.

Hereinafter, the method for manufacturing the diamond tool 10A will be explained with reference to an embodiment.

### Embodiment

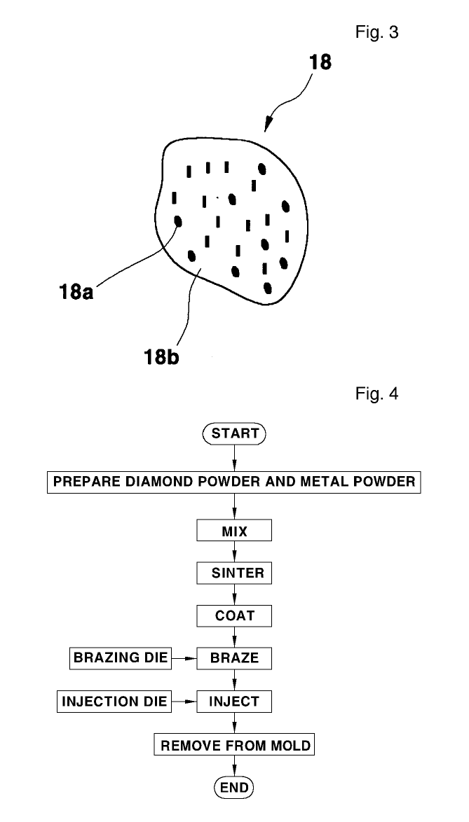

First, as shown in FIG. 3, the diamond pellets 18 is formed by mixing the diamond powder 18a with the metal powder 18b, sintering the mixture of the diamond powder and the metal powder at a general sintering temperature for diamond tool, and crushing the sintered to form the diamond pellets in irregular shape.

The diamond pellets 18 formed such as above is metal-coated on their surfaces for subsequent brazing binding.

In metal-coating, for example, Ni, Ti, Cu and so on can be selected as a coating material whose fusion

point is preferably higher than that of the selected brazing material.

Then, the coated diamond pellets 18 are placing in a brazing die prepared and brazing the same. Wherein, as a brazing material, nonferrous metal such as, for example, copper, silver solder, silver, brass solder and so on can be used.

The brazed diamond pellets 18 have a porous structure such as a sponge in which a plurality of holes are formed.

Then, the whole diamond pellets 18 are pacing, that is formed as one construction by the brazing at brazing die, between an injection die and the tool body 12, and then, injecting the resin 16 into a segment space formed between the injection die and the tool body 12 through a resin inlet 13 of the tool body 12.

Wherein, the resin inlet 13 can be formed on a forming die.

Injected resin 16 is filled in a space between a quantity of diamond pellets 18 to bind the same.

When the injected resin 16 is completely solidified, it is removed from the die thus to obtain a resin bonding type diamond tool 10A desired.

Wherein, depending upon a shape of die, various and complex shape of diamond tool may be obtained.

Meanwhile, the resin bonding type diamond tool of the present invention can be obtained by the method of sintering.

That is, the resin bonding type diamond tool of the present invention also can be manufactured, after providing resin powder 16 to the diamond pellets 18 coated and brazed through the former embodiment, pressing and sintering them at high temperature in the die to form the resin bonding type diamond tool.

Meanwhile, if the tool body 12 is made of metal in this embodiment, as shown in FIGS. 1A and 1B, a plurality of binding recesses 12a are formed to the tool body 12 and the resin 16 is bound to the binding recesses 12a through an injection or sintering thus to increase a binding force.

Also, upon filling of resin 16 using an injection, the tool body 12 is preferably made of the same resin so as to induce a fusion-binding therebetween.

According to this embodiment, since the resin 16 is fused and solidified in a state that the diamond pellets 18 are placed between the injection die and the tool body 12, the diamond tool of the present invention, if it has a very complex shape, can be

manufactured due to a fluidity of the resin 16.

Also, the diamond tool of the present invention can be manufactured by use of a single forming die and it does not require a separate post-grinding and welding processes so that manufacturing cost and time are considerably reduced.

Also, the tool body 12 can be node of resin so that the weight thereof may be reduced and power consumption by driving is thus reduced.

Furthermore, since the binding material is resin 16 which is possibly colored, the diamond tool can be classified by grain size according to color, which additionally provides a fine exterior view according to color.

### INDUSTRIAL APPLICABILITY

As can be seen from the foregoing, there is provided a diamond tool of the present invention in which the diamond pellets in powder type that can be adapted to all tools irrespective of their shapes are prepared by sintering the diamond powder and the metal powder so that it does not require to prepare various shapes of dies, the manufacturing cost and time are considerably reduced, complex and cheap tools can be

manufactured, and a cutting tool with excellent chip discharge ability and cutting capability can be produced.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method for manufacturing a resin bonding type diamond tool, the method comprising the steps of:
placing a tool body in a molding die;
loading a number of granular diamond pellets into a segment space formed between the molding die and the tool body, the diamond pellets being formed by sintering the mixture of diamond powder and metal powder; and
injecting resin into the segment space through the die or tool body so as to bind the diamond pellets with resin.

2. The method as claimed in claim 1, wherein the resin is injected through a resin inlet formed in the tool body.

3. The method as claimed in claim 1, wherein the diamond pellet has a size of 3 to 5 mm.

4. The method as claimed in claim 1, further comprising the steps of:
forming a plurality of binding recesses in the tool body; and
filling the resin into the binding recesses.

5. The method as claimed in claim 1, wherein the tool body is made of the same material as the resin.

6. The method as claimed in claim 1, further comprising the step of:
brazing the diamond pellets with at least one material selected from the group consisting of copper, silver solder, lead, brass solder and so on before the step of injecting resin so as to increase a binding force of the diamond pellets.

7. The method as claimed in claim 6, further comprising the step of:
coating the diamond pellets with at least one material selected from the group consisting of Ni, Ti, Cu and so on having a fusion point relatively higher than that of the selected brazing material before the step of brazing the diamond pellets so as to prevent the brazing material from being absorbed into the diamond pellets.

8. A method for manufacturing a resin bonding type diamond tool, the method comprising the steps of:
placing a tool body in a molding die;
loading a number of granular diamond pellets and resin powder into a segment space formed between the die and the tool body, the diamond pellets being formed by sintering the mixture of diamond powder and metal powder; and
sintering the mixture of the diamond pellets and the resin powder so as to bind the diamond pellets with the resin.

9. The method as claimed in claim 8, wherein the diamond pellet has a size of 3 to 5 mm.

10. The method as claimed in claim 8, further comprising the steps of:
forming a plurality of binding recesses in the tool body; and
filling the resin into the binding recesses.

11. The method as claimed in claim 8, wherein the tool body is made of the same material as the resin.

12. A resin bonding type diamond tool, comprising:
a tool body 12 made of metal or resin; and
a diamond tip 14 attached to the tool body 12, the diamond having resin 16 and a number of granular diamond pellets 18 contained in the resin 16, the diamond pellets 18 each containing a sintered mixture of diamond powder 18a and metal powder 18b therein.

13. The resin bonding type diamond tool as claimed in claim 12, wherein the diamond tip 14 has a binding projection 16a for increasing a binding force to the tool body 12.

14. The resin bonding type diamond tool as claimed in claim 12, wherein the tool body 12 is made of the same material as the resin 16 of the diamond tip 14.

15. The resin bonding type diamond tool as claimed in claim 12, wherein the tool body 12 has at least one resin inlet 13.

16. The resin bonding type diamond tool as claimed in claim 12, wherein the diamond pellets 18 are brazed and bound with at least one material selected from the group consisting of copper, silver solder, lead, brass solder and so on so as to increase a binding force.

17. The resin bonding type diamond tool as claimed in claim 12, wherein the diamond pellets 18 have a metal layer coated on their surfaces so as to prevent the brazing material from being absorbed into the diamond pellets, the metal layer being made of at least one material selected from the group consisting of Ni, Ti, Cu and so on having a fusion point relatively higher than that of the brazing material.
